(19) United States
(12) Patent Application Publication
(10) Pub. No.: US 2026/0301216 A1
(43) Pub. Date: Oct. 1, 2026

(54) VEHICLE, DETECTION METHOD, AND NON-TRANSITORY COMPUTER-READABLE STORAGE MEDIUM

(71) Applicant: HONDA MOTOR CO., LTD., Tokyo (JP)

(72) Inventors: Fumiaki Yoshikawa, Tokyo (JP); Hiroyuki Takasaki, Tokyo (JP)

(73) Assignee: HONDA MOTOR CO., LTD., Tokyo (JP)

(21) Appl. No.: 19/095,045

(22) Filed: Mar. 31, 2025

(51) Int. Cl. G06T 7/73; G01C 21/34; G06T 7/246; G06V 20/56

(52) U.S. Cl. CPC G06T 7/73; G01C 21/3461; G06T 7/246; G06V 20/56; G06T 2207/30204; G06T 2207/30241; G06T 2207/30252

(57) ABSTRACT

A processor of a vehicle for towing a trailer estimates a relative yaw angle of the trailer relative to the vehicle, based on position information of a detection object provided on the trailer in a trailer image or travel state information. The processor sets a predetermined search range in the trailer image, and performs a first search for the detection object within the predetermined search range. When the detection object is not detected within a predetermined search period of time in the first search, the processor uses the relative yaw angle estimated based on only the travel state information to set a re-search range having the same size with an outline of the detection object in the trailer image, on a trajectory of the detection object in the trailer image. The processor performs a second search for the detection object based on the re-search range.

### TECHNICAL FIELD

The present disclosure relates to a vehicle for towing a trailer, a detection method for a detection object provided in the trailer, and a non-transitory computer-readable storage medium storing a program causing a processor to perform the detection method.

### BACKGROUND ART

In recent years, active efforts have been made to provide access to a sustainable transportation system in consideration of vulnerable people among traffic participants. In order to implement the above, research and development on further improving safety and convenience of traffic by research and development related to driving assistance technology have been performed.

A trailer trajectory estimation system described in the description of US2016/0098604A captures an image of a trailer coupled to a rear portion of a vehicle, uses the captured image to estimate a coupling angle of the trailer, and displays the estimated coupling angle.

A system described in the description of US2021/0380109A estimates a change rate of a hitch angle between a trailer and a vehicle based on rotation angles of a plurality of rear wheels of the vehicle towing the trailer and a speed of the vehicle, and generates and displays a trajectory of the trailer based on the estimated change rate of the hitch angle.

A driver assistance described in JP2017-502867A obtains a speed vector at a rear portion of a host vehicle located in the vicinity of a trailer coupler and a speed vector at a front portion of the trailer located in the vicinity of the trailer coupler, determines whether a jackknife condition occurs based on the speed vector of the host vehicle and the speed vector of the trailer, and generates a warning signal when an occurrence of the jackknife condition is predicted. The speed vector of the host vehicle is obtained based on an acceleration, a steering angle, and the like of the host vehicle, and the speed vector of the trailer is obtained based on a trailer angle detected from an image obtained by imaging the trailer, and the like.

A towing assistance device described in JP2019-199150A captures an image of a marker provided on a towed vehicle with an in-vehicle camera of a towing vehicle, converts the captured image into an overhead image in a plan view from above, and obtains a bending angle of the towed vehicle relative to the towing vehicle based on a position of the marker in the overhead image.

The trajectory or behavior of the trailer is estimated based on the coupling angle (also referred to as the hitch angle, the trailer angle, and the bending angle) of the trailer. The coupling angle is typically estimated by detecting the marker of the trailer captured in the image obtained by imaging the trailer.

### SUMMARY OF INVENTION

An object of the present disclosure is to efficiently detect a detection object provided in a trailer from an image obtained by imaging the trailer, which hence contributes to development of a sustainable transportation system.

A first aspect of the present disclosure relates to a vehicle for towing a trailer, the vehicle including:

a camera configured to acquire a trailer image containing a detection object provided on the trailer;

a sensor configured to acquire travel state information of the vehicle; and

a processor configured to estimate a relative yaw angle of the trailer relative to the vehicle, based on at least one of position information of the detection object in the trailer image or the travel state information,

in which the processor is configured to:

set a predetermined search range in the trailer image, and perform a first search for the detection object within the predetermined search range,

in a case where the detection object is not detected within a predetermined search period of time in the first search, use the relative yaw angle estimated based on only the travel state information to set a re-search range, which has a size equal to an outline of the detection object in the trailer image, on a trajectory of the detection object, which moves according to a change in the relative yaw angle, in the trailer image, and

perform a second search for the detection object based on the re-search range.

A second aspect of the present disclosure relates to a server configured to perform wireless communication with a plurality of vehicles each towing a trailer,

in which each of the vehicles acquires a trailer image containing a detection object provided on the trailer, and acquires position information of the detection object in the trailer image to estimate a relative yaw angle of the trailer relative to the vehicle, and

the server

collects loss position information which is transmitted from each of the vehicles and which is position information of the vehicle in a case where the detection object in the trailer image is not detected within a predetermined search period of time,

generates a distribution map of points indicated by the collected loss position information, and

transmits the generated distribution map to each of the vehicles.

A third aspect of the present disclosure relates to a method of detecting a detection object, which is provided on a trailer towed by a vehicle, from a trailer image containing the detection object,

in which a processor performs the method having:

causing a camera provided in the vehicle to acquire the trailer image;

causing a sensor provided in the vehicle to acquire travel state information of the vehicle;

estimating a relative yaw angle of the trailer relative to the vehicle, based on at least one of the position information of the detection object in the trailer image or the travel state information;

setting a predetermined search range in the trailer image, and performing a first search for the detection object within the predetermined search range;

in a case where the detection object is not detected within a predetermined search period of time in the first search, using the relative yaw angle estimated based on only the travel state information to set a re-search range, which has a size equal to an outline of the detection object in the trailer image, on a trajectory of the detection object, which moves according to a change in the relative yaw angle, in the trailer image; and

performing a second search for the detection object based on the re-search range.

A fourth aspect of the present disclosure relates to a non-transitory computer-readable storage medium storing a program causing a processor to perform the method of the third aspect.

### BRIEF DESCRIPTION OF DRAWINGS

Exemplary embodiment(s) of the present invention will be described in detail based on the following figures, wherein:

FIG. 1 is a side view showing an example of a vehicle according to an aspect of the present disclosure;

FIG. 2 is a plan view of the vehicle of FIG. 1;

FIG. 3 is a functional block diagram of the vehicle of FIG. 1;

FIG. 4 is a flowchart of processing for detecting a detection object from a trailer image;

FIG. 5 is a schematic diagram showing a search range of a detection object in the detection processing of FIG. 4;

FIG. 6 is a schematic diagram showing a re-search range of the detection object in the detection processing of FIG. 4; and

FIG. 7 is a configuration diagram of a system including the vehicle of FIG. 1.

### DESCRIPTION OF EMBODIMENTS

Hereinafter, an example of a vehicle according to an aspect of the present disclosure will be described with reference to the accompanying drawings. The drawings are viewed from directions of reference numerals. In the present specification and the like, in order to simplify and clarify the description, a front-rear direction, a left-right direction, and an upper-lower direction are described according to directions viewed from a driver of a vehicle. In the drawings, a front side of the vehicle is shown as Fr, a rear side is shown as Rr, a left side is shown as L, a right side is shown as R, an upper side is shown as U, and a lower side is shown as D.

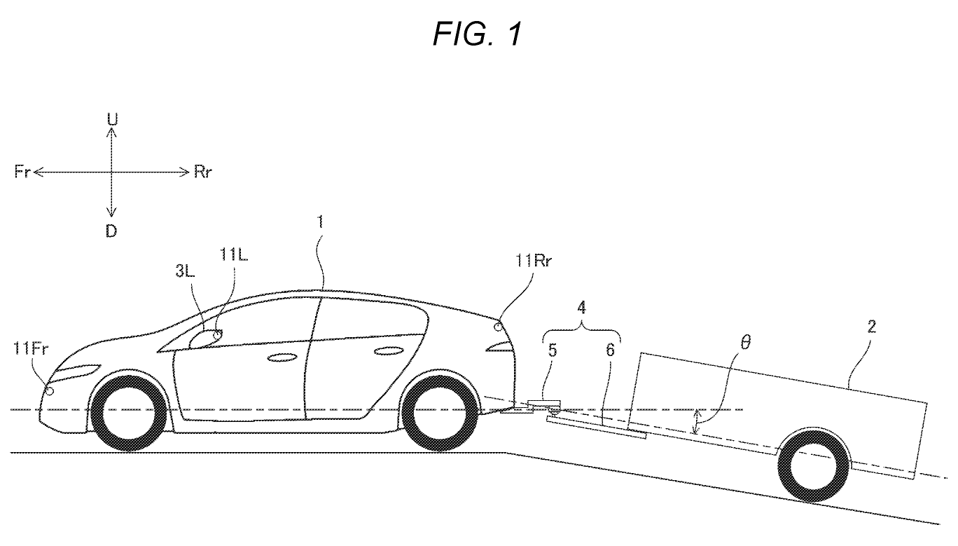

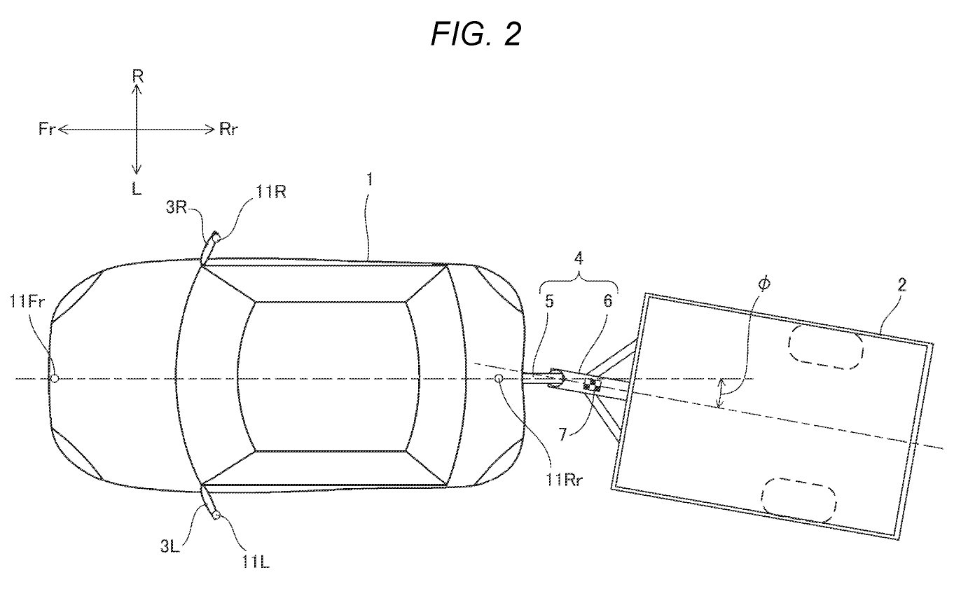

A vehicle 1 shown in FIGS. 1 and 2 is a four-wheel automobile including a pair of left and right front wheels and a pair of left and right rear wheels, and is an automobile capable of towing a trailer 2. A drive source of the vehicle 1 is an internal combustion engine such as a gasoline engine or a diesel engine, an electric motor, or a combination of the internal combustion engine and the electric motor. Both the pair of left and right front wheels and the pair of left and right rear wheels may be driven by the drive source, or any one of the pair of left and right front wheels and the pair of left and right rear wheels may be driven by the drive source. Alternatively, both the pair of left and right front wheels and the pair of left and right rear wheels may be steered wheels that are steerable, or any one of the pair of left and right front wheels and the pair of left and right rear wheels may be steered wheels.

The vehicle 1 includes side mirrors 3L and 3R. The side mirrors 3L and 3R are mirrors for a driver to check a rear side and rear lateral sides and are provided on outer sides of front seat doors of the vehicle 1.

The vehicle 1 includes a front camera 11Fr, a rear camera 11Rr, a left side camera 11L, and a right side camera 11R. The front camera 11Fr is a digital camera (image sensor) that images a front side of the vehicle 1 and is provided at a front portion of the vehicle 1. The rear camera 11Rr is a digital camera that images a rear side of the vehicle 1 and is provided on a rear portion of the vehicle 1. The left side camera 11L is a digital camera that images a left side of the vehicle 1 and is provided on the side mirror 3L on the left side of the vehicle 1. The right side camera 11R is a digital camera that images a right side of the vehicle 1 and is provided on the side mirror 3R on the right side of the vehicle 1.

The trailer 2 is coupled to the vehicle 1 via a coupling device 4. The coupling device 4 includes a vehicle arm 5 extending rearward from the rear portion of the vehicle 1, and a trailer arm 6 extending forward from a front portion of the trailer 2. The trailer 2 is coupled to the vehicle 1 by accommodating a hitch ball provided in the vehicle arm 5 into a coupler provided in the trailer arm 6.

The trailer 2 coupled to the vehicle 1 by the coupling device 4 is allowed to pitch, roll, and yaw relative to the vehicle 1. As shown in FIG. 1, an angle formed by an axle of the vehicle 1 and an axle of the trailer 2 when the vehicle 1 and the trailer 2 are viewed in a plan view in the left-right direction of the vehicle 1 is referred to as a relative pitch angle θ of the trailer 2 relative to the vehicle 1. As shown in FIG. 2, an angle formed by the axle of the vehicle 1 and the axle of the trailer 2 when the vehicle 1 and the trailer 2 are viewed in a plan view in the upper-lower direction of the vehicle 1 is referred to as a relative yaw angle φ of the trailer 2 relative to the vehicle 1.

A marker 7 serving as a detection object used for estimating the relative yaw angle is provided on an upper surface of the trailer arm 6. For example, the marker 7 may be provided in a form of a sticker, may be attached to the trailer arm 6, or may be provided by coating the trailer arm 6. The rear camera 11Rr of the vehicle 1 is installed on an upper side of the rear portion of the vehicle 1 to look down the trailer arm 6 from above. A rear image acquired by the rear camera 11Rr includes the trailer 2 including the marker 7 and a road surface.

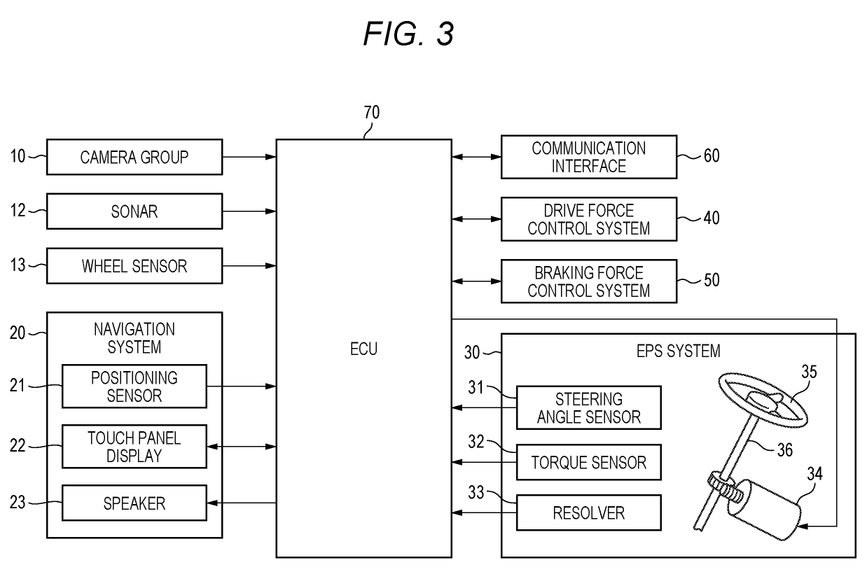

As shown in FIG. 3, the vehicle 1 includes a sensor group, a navigation system 20, an electric power steering (EPS) system 30, a drive force control system 40, a braking force control system 50, a communication interface 60, and an electronic control unit (ECU) 70 that integrally controls the devices.

The sensor group acquires various detection values used for control of the vehicle 1. A camera group 10 including the front camera 11Fr, the rear camera 11Rr, the left side camera 11L, and the right side camera 11R is also included in the sensor group. The sensor group further includes a sonar 12 for detecting an obstacle or the like present in the surroundings of the vehicle 1 and a wheel sensor 13 for acquiring information related to a travel state of the vehicle 1.

The front camera 11Fr, the rear camera 11Rr, the left side camera 11L, and the right side camera 11R acquire a front image, a rear image, a left side image, and a right side image of the vehicle 1. The ECU 70 generates a surrounding image of the vehicle 1 using images acquired by the front camera 11Fr, the rear camera 11Rr, the left side camera 11L, and the right side camera 11R. The surrounding image is, for example, a two-dimensional image or a three-dimensional image in which the vehicle 1 is overlooked. Images of the vehicle 1 and the trailer 2 prepared in advance may be combined with the surrounding image.

The sonar 12 emits sound waves to the surroundings of the vehicle 1 and receives a reflected sound. The ECU 70 detects an obstacle or the like present in the surroundings of the vehicle 1 based on a direction of the received reflected sound and a time from the emission of the sound waves to the reception of the reflected sound and detects a direction and a distance in which the obstacle or the like is present. The sensor group may include, as a sensor for detecting the obstacle or the like present in the surroundings of the vehicle 1, a sensor such as a radar or Lidar (Light Detection and Ranging or Laser Imaging Detection and Ranging) instead of the sonar 12 or in addition to the sonar 12.

The wheel sensor 13 detects rotation angles of the respective wheels including the pair of left and right front wheels and the pair of left and right rear wheels of the vehicle 1. The wheel sensor 13 is, for example, an angle sensor or a displacement sensor, and outputs a pulse signal each time the wheel rotates by a predetermined angle. The ECU 70 calculates the rotation angle and a rotation speed of each wheel from the pulse signal output from the wheel sensor 13 and further calculates a speed and a moving distance of the vehicle 1.

The navigation system 20 includes a positioning sensor 21 that detects a current position of the vehicle 1, a touch panel display 22, a speaker 23, and a memory (not shown) that stores map information. The positioning sensor 21 is, for example, a Global Positioning System (GPS) sensor. The navigation system 20 guides a travel route to a destination to an occupant of the vehicle 1 based on position information of the vehicle 1 detected by the positioning sensor 21 and the map information stored in the memory. The guidance is presented to the occupant through the touch panel display 22 or the speaker 23.

The touch panel display 22 functions as one of an input interface to the ECU 70 and an output destination of display processing and/or notification processing performed by the ECU 70. The speaker 23 functions as an output destination of notification processing performed by the ECU 70.

The EPS system 30 includes a steering angle sensor 31, a torque sensor 32, a resolver 33, and an EPS motor 34. The steering angle sensor 31 detects a steering angle of a steering wheel 35. The torque sensor 32 detects a torque applied to the steering wheel 35. The resolver 33 detects a rotation angle of the EPS motor 34. The ECU 70 drives the EPS motor 34 to apply a drive force or a reaction force to a steering column 36 coupled to the steering wheel 35 based on the steering angle, the torque, and the rotation angle, thereby assisting an operation of the occupant on the steering wheel 35.

Under the control of the ECU 70, the drive force control system 40 controls a drive force of the vehicle 1 by operating a drive source or the like of the vehicle 1 in response to an operation of the occupant on an accelerator pedal or the like. Under the control of the ECU 70, the braking force control system 50 controls a braking force of the vehicle 1 by operating a brake mechanism or the like of the vehicle 1 in response to an operation of the occupant on the brake pedal or the like.

The communication interface 60 performs wireless communication with another communication device under the control of the ECU 70. The other communication device is a base station, a communication device of another vehicle, an information terminal such as a smartphone carried by the occupant of the vehicle 1, or the like.

The ECU 70 includes a processor and a memory that stores programs to be executed by the processor and various types of data to be used during the execution of the programs. By the processor operating according to the programs, the ECU 70 realizes the various functions described above, such as the steering wheel operation assistance, the drive force control, and the braking force control. The ECU 70 can realize automated driving and automated parking based on cooperation of the sensor group, the navigation system 20, the EPS system 30, the drive force control system 40, and the braking force system 50. The ECU 70 may include a plurality of processors divided for respective functions such as the steering wheel operation assistance, the drive force control, and the braking force control.

The ECU 70 estimates the relative yaw angle φ of the trailer 2 based on at least one of the position information of the marker 7 in the trailer image, which is an image obtained by the rear camera 11Rr and contains the marker 7 of the trailer 2, or the travel state information of the vehicle 1 (that is, based on the position information, the travel state information, or both information). The travel state information is, for example, the steering angle detected by the steering angle sensor 31 and a wheel speed detected by the wheel sensor 13.

The ECU 70 detects the marker 7 in the trailer image using, for example, pattern matching. A template image of the marker 7 is registered in advance in the memory of the ECU 70. The ECU 70 detects an image that matches the template image or image locations that match features of the template image as the marker 7 in the trailer image. The marker 7 may include, for example, a grid pattern including one or more grid points, and the grid points of the grid pattern may be feature points of the marker 7 and the template image of the marker 7 in the pattern matching.

The marker 7 in a real space moves in an arc-shaped trajectory centered on the hitch ball of the coupling device 4 depending on a change in the relative yaw angle φ. Therefore, the marker 7 in the trailer image also moves along the arc-shaped trajectory. The ECU 70 specifies a position of the detected marker 7 on the arc-shaped trajectory in the trailer image, and estimates the relative yaw angle φ based on the specified position information of the marker 7.

Further, the relative yaw angle φ can be represented by an equation of motion in which a motion model created based on various specifications of the vehicle 1 and the trailer 2 is used and the steering angle and the wheel speed of the vehicle 1 are variables. The ECU 70 estimates a current relative yaw angle φ based on the relative yaw angle φ at a past time point and the travel state information including a current steering angle and wheel speed. In the estimation, for example, a Karman filter can be used.

Further, the relative yaw angle φ estimated based on the position information of the marker 7 and the relative yaw angle φ estimated based on the travel state information pass through the Karman filter, and thus accuracy of the relative yaw angle φ estimated based on the position information of the marker 7 can be improved using the relative yaw angle φ estimated based on the travel state information.

The ECU 70 basically adopts the relative yaw angle φ estimated based on the position information of the marker 7 as the relative yaw angle φ of the trailer 2, but in a case where the estimation based on the position information of the marker 7 cannot be performed, the relative yaw angle φ estimated based on the travel state information is adopted as the relative yaw angle φ of the trailer 2. Examples of the case where the estimation based on the position information of the marker 7 cannot be performed include a case where the marker 7 in the trailer image cannot be detected. Examples of factors that hinder the detection of the marker 7 include disappearance of the feature points of the marker 7 caused by a dirt adhered to the marker 7, reflection of a surface of the marker 7, and shadow reflected on the marker 7, and the marker 7 being is buried in markings of the road surface contained in the trailer image.

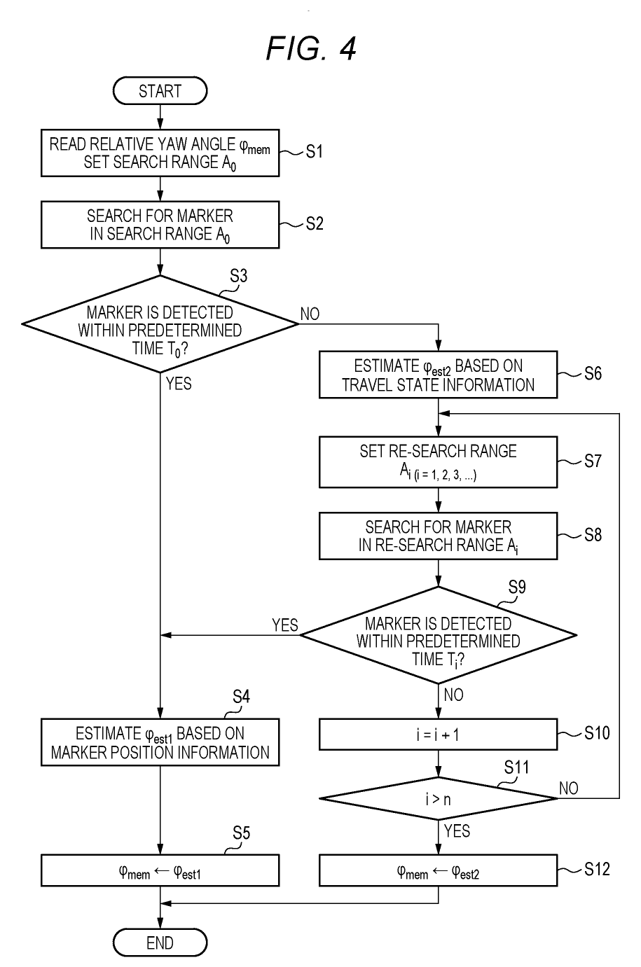

FIG. 4 shows processing for detecting the marker 7 from the trailer image, which is performed by the ECU 70.

The ECU 70 stores the relative yaw angle φ obtained by the estimation processing of the relative yaw angle φ executed immediately before in the memory, uses the relative yaw angle φₘₑₘ stored in the memory to set a search range of the marker 7 in the trailer image, and searches for the marker 7 in the trailer image. Immediately after an ignition of the vehicle 1 is turned on, that is, immediately after a vehicle system is started, the ECU 70 may search an entire range of the trailer image or an entire range of the arc-shaped trajectory of the marker 7 in the trailer image, but preferably, the relative yaw angle φ at a time point when the vehicle system is stopped in a previous travel is stored in the memory, the relative yaw angle φₘₑₘ stored in the memory is used to set a search range of the marker 7 in the trailer image, and the marker 7 is searched for.

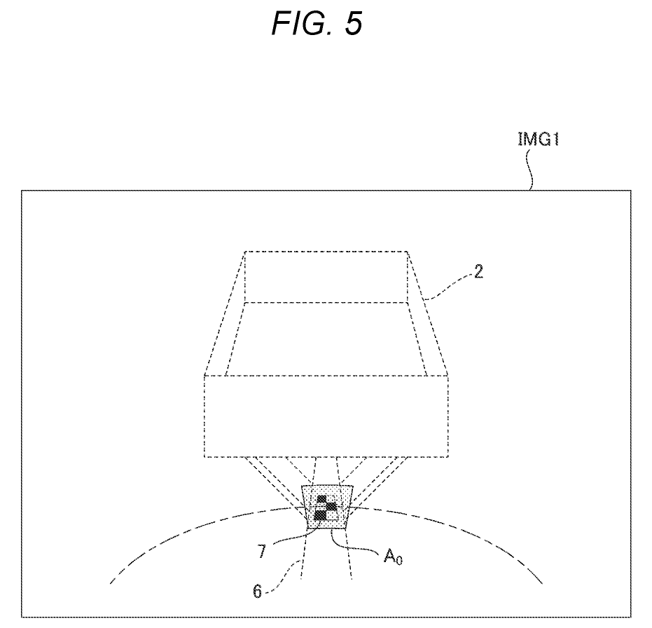

First, the ECU 70 reads the relative yaw angle φₘₑₘ stored in the memory and uses the relative yaw angle φₘₑₘ read from the memory to set a search range A₀ of the marker 7 in the trailer image (step S1). Referring to FIG. 5, the search range A₀ has a size equal to an outline of the marker 7 in a trailer image IMG1, and the ECU 70 arranges the search range A₀ at a position corresponding to the relative yaw angle φₘₑₘ on the arc-shaped trajectory of the marker 7. The search range A₀ having the same size as the outline of the marker 7 may at least include the marker 7 and is preferably a fan shape concentric with the arc-shaped trajectory of the marker 7 and having a minimum size that can include the marker 7.

The ECU 70 attempts to detect the marker 7 in the search range A₀ set in the trailer image (step S2). When the marker 7 is detected within the search range A₀ before a time that has elapsed since the start of the search in the search range A₀ reaches a predetermined time T₀ (step S3: Yes), the ECU 70 specifies a position of the detected marker 7 on the arc-shaped trajectory in the trailer image and estimates the relative yaw angle φ based on the specified position information of the marker 7 (step S4). Then, the ECU 70 updates the relative yaw angle φₘₑₘ stored in the memory based on a relative yaw angle φₑₛₜ₁ estimated in step S3 (step S5) and ends the processing.

On the other hand, when the marker 7 cannot be detected within the search range A₀ before the time that has elapsed since the start of the search in the search range A₀ reaches the predetermined time T₀ (step S3: No), the ECU 70 estimates the current relative yaw angle φ based on the relative yaw angle φₘₑₘ stored in the memory and the travel state information including the current steering angle and wheel speed (step S6).

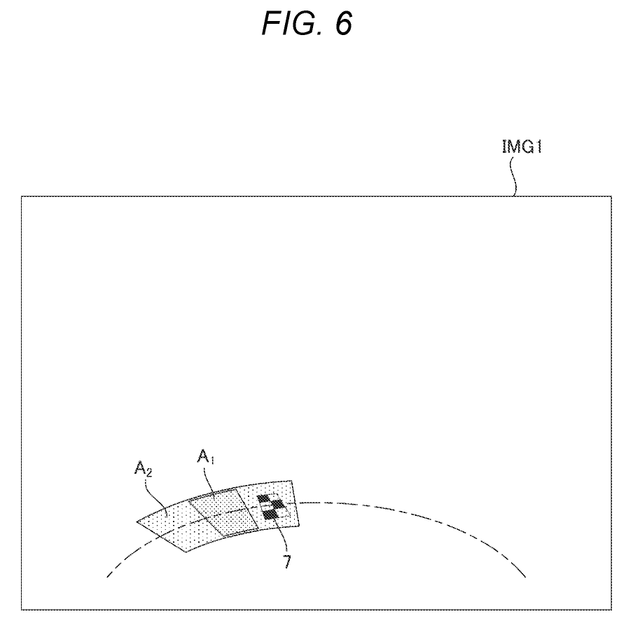

Next, the ECU 70 uses a relative yaw angle φₑₛₜ₂ estimated in step S6 to set a re-search range Aᵢ (i = 1, 2, 3, ...) of the marker 7 in the trailer image (step S7). Referring to FIG. 6, the re-search range A₁ at the beginning of the re-search has a size equal to the outline of the marker 7 in the trailer image IMG1, and the ECU 70 arranges the re-search range A₁ at a position corresponding to the relative yaw angle φₑₛₜ₂ on the arc-shaped trajectory of the marker 7. The re-search range A₁ having the same size as the outline of the marker 7 may at least include the marker 7 and is preferably a fan shape concentric with the arc-shaped trajectory of the marker 7 and having a minimum size that can include the marker 7.

Then, the ECU 70 attempts to detect the marker 7 in the re-search range Aᵢ set in step S6 (step S8). When the marker 7 is detected within the re-search range Aᵢ before a time that has elapsed since the start of the search in the re-search range Aᵢ reaches a predetermined time Tᵢ (i = 1, 2, 3, ...) (step S9: Yes), the ECU 70 shifts to step S4 and estimates the relative yaw angle φ based on the position information of the marker 7.

On the other hand, when the marker 7 cannot be detected within the re-search range Aᵢ before the time that has elapsed since the start of the search in the re-search range Aᵢ reaches the predetermined time Tᵢ (step S9: No), the ECU 70 expands the re-search range Aᵢ of the marker 7 from a previous re-search range Aᵢ₋₁ (step S10). As shown in FIG. 6, the re-search range Aᵢ of marker 7 may be expanded in both a first direction and a second direction along the arc-shaped trajectory of marker 7 in the trailer image IMG1, or may be expanded first in the first direction and then expanded in the second direction after reaching an end of the arc-shaped trajectory in the first direction. Then, the ECU 70 attempts to detect the marker 7 in the expanded re-search range Aᵢ. The predetermined time Tᵢ, which is the search time for the corresponding re-search range Aᵢ, may be constant and the same as the predetermined time T₀, which is the search time for the search range A₀, or may be gradually extended considering that the re-search range Aᵢ is expanded gradually.

When the marker 7 cannot be detected even if the detection of the marker 7 in the re-search range Aᵢ and the expansion of the re-search range Aᵢ are repeated a predetermined number of times n (step S11: No), the ECU 70 updates the relative yaw angle φₘₑₘ stored in the memory based on the relative yaw angle φₑₛₜ₂ estimated in step S5 (step S12), and ends the processing.

### The ECU 70 periodically detects the marker 7.

In the detection processing of the marker 7 described above, first, it is attempted to detect the marker 7 in the search range A₀ set using the relative yaw angle φₘₑₘ stored in the memory, that is, the relative yaw angle φ obtained in the estimation processing of the relative yaw angle executed immediately before, and thus the marker 7 can be detected more efficiently than attempting to perform the detection in the entire range of the trailer image or the entire range on the arc-shaped trajectory of the marker 7. Further, when the marker 7 cannot be detected in the search range A₀, the relative yaw angle φₑₛₜ₂estimated based on the relative yaw angle φₘₑₘ stored in the memory and the travel state information including the current steering angle θst and wheel speed is used to set the re-search range Aᵢ, and it is attempted to repeat the detection of the marker 7 while expanding the re-search range Aᵢ gradually, and thus the marker 7 can be detected more efficiently than attempting to perform the detection in the entire range of the trailer image or the entire range on the arc-shaped trajectory of the marker 7.

Then, it is attempted to detect the marker 7 within the range of the search range A₀ and the re-search range A₁ having the same size as the outline of the marker 7 and the re-search range Aᵢ gradually expanded from the re-search range A₁, it is possible to effectively reduce a possibility of erroneously detecting the markings on the road surface contained in the trailer image as the marker 7, and to improve detection accuracy of the marker 7.

In the detection processing of the marker 7 shown in FIG. 4, when the marker 7 is not detected within the search range A₀ before the time that has elapsed since the start of the search in the search range A₀ reaches the predetermined time T₀ (step S3: No), the ECU 70 may acquire the current position of the vehicle 1 at that time point from the positioning sensor 21 and store the current position in the memory. The loss position information of the marker 7 thus obtained can be utilized in various ways.

As one example of utilizing the loss position information, when the vehicle 1 is approaching a loss point indicated by the loss position information stored in the memory, that is, a point at which the detection of the marker 7 has failed in the past, the ECU 70 performs notification processing for the occupant of the vehicle 1. For example, when the loss point is present on the travel route to the destination set in the navigation system 20 and the vehicle 1 arrives at a point predetermined distance before the loss point, the ECU 70 displays, on the touch panel display 22, a text or an image for calling attention of the occupant, and/or outputs a voice message for calling attention of the occupant via the speaker 23. Further, the ECU 70 may transmit an instruction to an information terminal such as a smartphone carried by the occupant via the communication interface 60 and output a similar text, image, voice message, or the like from a touch panel display or a speaker of the information terminal. The occupant of the vehicle 1 can take measures to prevent a detection failure of the marker 7, based on the notification processing performed by the ECU 70. The preventive measure is, for example, deceleration of the vehicle 1 or self-limiting of a sudden steering operation.

As another example of utilizing the loss position information, in a case where the loss point is included on the travel route to the destination set in the navigation system 20, the ECU 70 performs notification processing for the occupant of the vehicle 1. Accordingly, an opportunity to set a travel route avoiding the loss point in advance can be provided to the occupant.

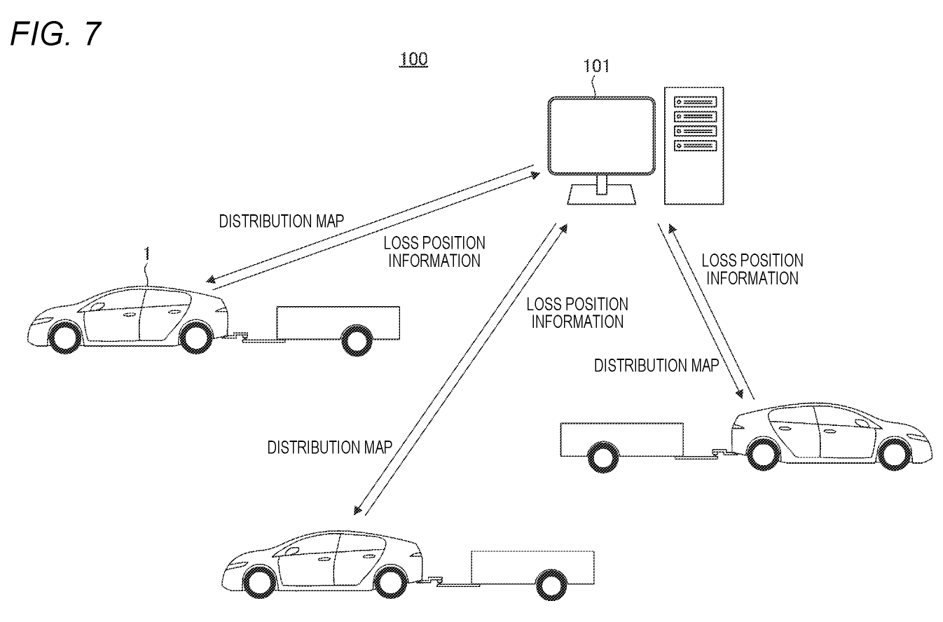

Convenience can be further improved by using the loss position information collected by a vehicle different from the vehicle 1. A system 100 shown in FIG. 7 includes a plurality of vehicles including the vehicle 1 and a server 101 that collects the loss position information from each of the vehicles.

In the detection processing of the marker 7 shown in FIG. 4, when the marker 7 is not detected within the search range A₀ before the time that has elapsed since the start of the search in the search range A₀ reaches the predetermined time T₀ (step S3: No), the ECU 70 of the vehicle 1 acquires the current position of the vehicle 1 at that time from the positioning sensor 21. Then, the ECU 70 transmits the acquired position information as the loss position information of the marker 7 to the server 101 via the communication interface 60. Other vehicles each have a configuration similar to that of the vehicle 1, and when the loss position information is acquired, the acquired loss position information is transmitted to the server 101.

The server 101 includes a processor and a memory that stores programs to be executed by the processor and various types of data to be used during the execution of the programs. By the processor operating according to the programs, the server 101 realizes functions of collecting the loss position information from the plurality of vehicles including the vehicle 1, generating a distribution map of the loss points indicated by the collected loss position information, and transmitting the generated distribution map to the plurality of vehicles. A form of the distribution map is not particularly limited, and for example, each of the loss points may be plotted on a map, or the number of the loss points may be counted in units of area meshes obtained by appropriately dividing a map, and an area including a certain number of the loss points or more may be extracted as a point where the loss occurs frequently.

The plurality of vehicles including the vehicle 1 each transmit a distribution map transmission request to the server 101 periodically or when the vehicle system is started up, and receive the distribution map transmitted from the server 101 in response to the transmission request. Alternatively, the server 101 may periodically and automatically distribute the distribution map to the plurality of vehicles including the vehicle 1, and the plurality of vehicles including the vehicle 1 may receive the distribution map distributed automatically from the server 101.

The ECU 70 of the vehicle 1 stores the received distribution map in the memory, and updates the distribution map stored in the memory based on the received distribution map. When the vehicle 1 is approaching the point indicated by the distribution map and/or in the case where the point indicated by the distribution map is included on the travel route to the destination set in the navigation system 20, the ECU 70 performs notification processing for the occupant of the vehicle 1. Other vehicles are configured similarly.

Thus, the loss position information is collected from the plurality of vehicles including the vehicle 1, and the collected loss position information is used by the plurality of vehicles, which enables effective notification processing in each of the vehicles. Accordingly, the occupant of each vehicle can take measures to prevent the detection failure of the marker, for example, and can set the travel route avoiding the loss point in advance.

The embodiment of the present disclosure has been described above, but the present invention is not limited to the embodiment described above, and modifications, improvements, and the like can be made as appropriate. In the present description, at least the following matters are described. Although corresponding constituent elements or the like in the above-described embodiment are shown in parentheses, the present invention is not limited thereto.

(1) A vehicle (vehicle 1) for towing a trailer (trailer 2) including:
a camera (rear camera 11Rr) configured to acquire a trailer image (IMG1) containing a detection object (marker 7) provided on the trailer;
a sensor (wheel sensor group 13, steering angle sensor 31) configured to acquire travel state information of the vehicle; and
a processor (ECU 70) configured to estimate a relative yaw angle of the trailer relative to the vehicle, based on at least one of position information of the detection object in the trailer image or the travel state information,
in which the processor is configured to:
   set a predetermined search range (search range A₀) in the trailer image, and perform a first search for the detection object within the predetermined search range;
   in a case where the detection object is not detected within a predetermined search period of time in the first search, use the relative yaw angle (relative yaw angle φₑₛₜ₂) estimated based on only the travel state information to set a re-search range (re-search range Aᵢ), which has a size equal to an outline of the detection object in the trailer image, on a trajectory of the detection object, which moves according to a change in the relative yaw angle, in the trailer image; and
   perform a second search for the detection object based on the re-search range.

According to the vehicle of the above (1), the detection object can be detected more efficiently than attempting to perform the detection in an entire range of the trailer image or an entire range on the trajectory of the detection object. Further, it is possible to effectively reduce a possibility of erroneously detecting markings on a road surface contained in the trailer image as the detection object and to improve detection accuracy of the detection object.

(2) The vehicle according to the above (1),
in which the processor is configured to use the relative yaw angle estimated recently to set a search range having a size equal to the outline of the detection object in the trailer image on the trajectory, as the predetermined search range in the first search.

According to the vehicle of the above (2), the detection object can be efficiently detected.

(3) The vehicle according to the above (2),
in which the processor is configured to:
   store, in a memory, the relative yaw angle immediately before a vehicle system that estimates the relative yaw angle is stopped; and
   in the first search when the vehicle system is started up, use the relative yaw angle (relative yaw angle φₘₑₘ) stored in the memory to set the predetermined search range.

According to the vehicle of the above (3), the detection object can be efficiently detected.

(4) The vehicle according to the above (1),
in which the processor is configured to repeat a search for the detection object while expanding the re-search range along the trajectory, in the second search.

According to the vehicle of the above (4), the detection object can be efficiently detected.

(5) The vehicle according to the above (1) further including:
a positioning sensor (positioning sensor 21) configured to acquire vehicle position information,
in which the processor is configured to:
   store, in a memory, the vehicle position information of the case where the detection object is not detected within the predetermined search period of time in the first search, as loss position information; and
   perform notification processing for an occupant of the vehicle when the vehicle is approaching a point indicated by the loss position information stored in the memory.

According to the vehicle of the above (5), the occupant of the vehicle can take measures to prevent a detection failure of the detection object, based on the notification processing.

(6) The vehicle according to the above (5), further including:
a navigation (navigation system 20) configured to guide a travel route to a destination using the vehicle position information,
in which the processor is configured to perform the notification processing for the occupant of the vehicle in a case where the point indicated by the loss position information stored in the memory is included on the travel route.

According to the vehicle of the above (6), an opportunity to set a travel route avoiding the loss point in advance can be provided to the occupant.

(7) The vehicle according to the above (5), further including:
a communication interface (communication interface 60) configured to perform wireless communication with an external server (server 101) that collects the loss position information and generates a distribution map of points indicated by the loss position information,
in which the processor is configured to:
   transmit the loss position information to the external server via the communication interface;
   receive the distribution map from the external server via the communication interface; and
   perform the notification processing for the occupant of the vehicle when the vehicle is approaching one of the points contained in the distribution map.

According to the vehicle of the above (7), by using the distribution map created based on the loss position information collected from a plurality of vehicles in the notification processing, more effective notification processing can be performed.

(8) The vehicle according to the above (7), further including:
a navigation configured to guide a travel route to a destination using the vehicle position information,
in which the processor is configured to perform the notification processing for the occupant of the vehicle in a case where a point contained in the distribution map is included on the travel route.

According to the vehicle of the above (8), by using the distribution map created based on the loss position information collected from a plurality of vehicles in the notification processing, more effective notification processing can be performed.

(9) The vehicle according to the above (1),
in which the detection object is provided on an upper surface of an arm (trailer arm 6) for coupling the trailer to the vehicle, and
the camera is installed on an upper side of a rear portion of the vehicle to look down the arm from above.

(10) The vehicle according to the above (1),
in which the detection object has a grid pattern including one or more grid points, and
the processor is configured to detect the detection object using the one or more grid points as feature points.

(11) A server (server 101) configured to perform wireless communication with a plurality of vehicles (vehicle 1) each towing a trailer (trailer 2),
in which each of the vehicles acquires a trailer image containing a detection object (marker 7) provided on the trailer, and acquires position information of the detection object in the trailer image to estimate a relative yaw angle (relative yaw angle φ) of the trailer relative to the vehicle, and
the server
   collects loss position information which is transmitted from each of the vehicles and which is position information of the vehicle in a case where the detection object in the trailer image is not detected within a predetermined search period of time,
   generates a distribution map of points indicated by the collected loss position information, and
   transmits the generated distribution map to each of the vehicles.

According to the server of the above (11), the loss position information is collected from the plurality of vehicles, the distribution map of the points indicated by the collected loss position information is generated, and the generated distribution map can be used in the plurality of vehicles. Accordingly, effective notification processing based on the distribution map can be performed in each of the vehicles.

(12) A method of detecting a detection object, which is provided on a trailer towed by a vehicle, from a trailer image containing the detection object,
in which a processor performs the method including:
causing a camera provided in the vehicle to acquire the trailer image;
causing a sensor provided in the vehicle to acquire travel state information of the vehicle;
estimating a relative yaw angle of the trailer relative to the vehicle, based on at least one of the position information of the detection object in the trailer image or the travel state information;
setting a predetermined search range in the trailer image, and performing a first search for the detection object within the predetermined search range;
in a case where the detection object is not detected within a predetermined search period of time in the first search, using the relative yaw angle estimated based on only the travel state information to set a re-search range, which has a size equal to an outline of the detection object in the trailer image, on a trajectory of the detection object, which moves according to a change in the relative yaw angle, in the trailer image; and
performing a second search for the detection object based on the re-search range.

According to the method of the above (12), the detection object can be detected more efficiently than attempting to perform the detection in the entire range of the trailer image or the entire range on the trajectory of the detection object. Further, it is possible to effectively reduce the possibility of erroneously detecting the markings on the road surface contained in the trailer image as the detection object and to improve the detection accuracy of the detection object.

(13) A non-transitory computer-readable storage medium storing a program causing a processor to perform the method according to (12).

What is claimed is:

1. A vehicle for towing a trailer, the vehicle comprising:
a camera configured to acquire a trailer image containing a detection object provided on the trailer;
a sensor configured to acquire travel state information of the vehicle; and
a processor configured to estimate a relative yaw angle of the trailer relative to the vehicle, based on at least one of position information of the detection object in the trailer image or the travel state information,
wherein the processor is configured to:
set a predetermined search range in the trailer image, and perform a first search for the detection object within the predetermined search range;
in a case where the detection object is not detected within a predetermined search period of time in the first search, use the relative yaw angle estimated based on only the travel state information to set a re-search range, which has a size equal to an outline of the detection object in the trailer image, on a trajectory of the detection object, which moves according to a change in the relative yaw angle, in the trailer image; and
perform a second search for the detection object based on the re-search range.

2. The vehicle according to claim 1,
wherein the processor is configured to use the relative yaw angle estimated recently to set a search range having a size equal to the outline of the detection object in the trailer image on the trajectory, as the predetermined search range in the first search.

3. The vehicle according to claim 2,
wherein the processor is configured to:
store, in a memory, the relative yaw angle immediately before a vehicle system that estimates the relative yaw angle is stopped; and
in the first search when the vehicle system is started up, use the relative yaw angle stored in the memory to set the predetermined search range.

4. The vehicle according to claim 1,
wherein the processor is configured to repeat a search for the detection object while expanding the re-search range along the trajectory, in the second search.

5. The vehicle according to claim 1, further comprising:
a positioning sensor configured to acquire vehicle position information,
wherein the processor is configured to:
store, in a memory, the vehicle position information of the case where the detection object is not detected within the predetermined search period of time in the first search, as loss position information; and
perform notification processing for an occupant of the vehicle when the vehicle is approaching a point indicated by the loss position information stored in the memory.

6. The vehicle according to claim 5, further comprising:
a navigation configured to guide a travel route to a destination using the vehicle position information,
wherein the processor is configured to perform the notification processing for the occupant of the vehicle in a case where the point indicated by the loss position information stored in the memory is included on the travel route.

7. The vehicle according to claim 5, further comprising:
a communication interface configured to perform wireless communication with an external server that collects the loss position information and generates a distribution map of points indicated by the loss position information,
wherein the processor is configured to:
transmit the loss position information to the external server via the communication interface;
receive the distribution map from the external server via the communication interface; and
perform the notification processing for the occupant of the vehicle when the vehicle is approaching one of the points in the distribution map.

8. The vehicle according to claim 7, further comprising:
a navigation configured to guide a travel route to a destination using the vehicle position information,
wherein the processor is configured to perform the notification processing for the occupant of the vehicle in a case where a point contained in the distribution map is included on the travel route.

9. The vehicle according to claim 1,
wherein the detection object is provided on an upper surface of an arm for coupling the trailer to the vehicle, and
the camera is installed on an upper side of a rear portion of the vehicle to look down the arm from above.

10. The vehicle according to claim 1,
wherein the detection object has a grid pattern including one or more grid points, and
the processor is configured to detect the detection object using the one or more grid points as feature points.

11. A server configured to perform wireless communication with a plurality of vehicles each towing a trailer,
wherein each of the vehicles acquires a trailer image containing a detection object provided on the trailer, and acquires position information of the detection object in the trailer image to estimate a relative yaw angle of the trailer relative to the vehicle, and
the server
collects loss position information which is transmitted from each of the vehicles and which is position information of the vehicle in a case where the detection object in the trailer image is not detected within a predetermined search period of time,
generates a distribution map of points indicated by the collected loss position information, and
transmits the generated distribution map to each of the vehicles.

12. A method of detecting a detection object, which is provided on a trailer towed by a vehicle, from a trailer image containing the detection object,
wherein a processor performs the method comprising:
causing a camera provided in the vehicle to acquire the trailer image;
causing a sensor provided in the vehicle to acquire travel state information of the vehicle;
estimating a relative yaw angle of the trailer relative to the vehicle, based on at least one of the position information of the detection object in the trailer image or the travel state information;
setting a predetermined search range in the trailer image, and performing a first search for the detection object within the predetermined search range;
in a case where the detection object is not detected within a predetermined search period of time in the first search, using the relative yaw angle estimated based on only the travel state information to set a re-search range, which has a size equal to an outline of the detection object in the trailer image, on a trajectory of the detection object, which moves according to a change in the relative yaw angle, in the trailer image; and
performing a second search for the detection object based on the re-search range.

13. A non-transitory computer-readable storage medium storing a program causing a processor to perform the method according to claim 12.
